(19) United States
(12) Patent Application Publication
(10) Pub. No.: US 2019/0119951 A1
(43) Pub. Date: Apr. 25, 2019

(54) DOOR LOCK AND METHOD OF INSTALLATION AND UN-INSTALLATION OF THE SAME

(71) Applicant: TAIWAN FU HSING INDUSTRIAL CO., LTD., Kaohsiung City (TW)

(72) Inventor: FU-CHIH HUANG, KAOHSIUNG CITY (TW)

(21) Appl. No.: 15/859,847

(22) Filed: Jan. 2, 2018

(30) Foreign Application Priority Data
Oct. 20, 2017 (TW) 106136018

(51) Int. Cl. E05B 55/00; E05B 9/08; E05B 9/00; E05B 9/04

(52) U.S. Cl. CPC E05B 55/005; E05B 9/04; E05B 9/002; E05B 9/084

(57) ABSTRACT

A door lock and a method for installation and un-installation of the door lock, includes a lock plate unit and a lock unit. The lock plate unit having an installation hole, an inside face and a cylinder hole. The installation hole includes a first guide and the lock unit includes a second guide. The lock unit includes a latch unit. When installing the door lock, the lock unit is simply installed to the installation hole and rotated. When un-installing the door lock, the latch unit is simply pushed to be disengaged from the cylinder hole, and the lock unit is rotated to remove the lock unit from the lock plate unit without using any tool and without damaging the lock plate unit.

### BACKGROUND OF THE INVENTION

### 1. Fields of the Invention

The present invention relates to a door lock, and more particularly, to a door lock and a method of installation and un-installation of the door lock without removal of the face plate.

### 2. Descriptions of Related Art

The door locks are used for providing safety and security to goods, and the door locks are locked and unlocked by using authorized keys. The door locks are connected to a back plate, and the door lock and the back plate are connected to a face plate to secure the door lock to the door. The face plate is the only part that is exposed at the outside face of the door. The face plate is shaped according to the outer appearance of the lock and may be made to be different geometric shapes to enhance the aesthetic purposes.

The casing of the door lock includes extension parts, and the back plate includes a hole that is shaped to be matched with the casing of the door lock. There are slots defined in the periphery of the hole and shaped to match with the extension parts. The back plate has recesses defined in the rear face thereof and the recesses are located corresponding to the extension parts. The recesses are located not corresponding to the slots. When the casing of the door lock and the extension parts extend through the hole and the slots, the combination of the door lock and the extension parts is rotated to engage the extension parts with the recesses. The face plate is then connected to the back plate. The casing of the door lock is secured by positioning the extension parts between the recesses and the face plate. The installation processes are complicated and require a lot of time. Furthermore, when the face plate needs to be replaced with another one of different shape, or when the door lock needs to be replaced, because the face plate and the back plate are connected with each other by way of riveting, welding or pressing, so that a tool is required to be inserted between the face plate and the back plate to force separate the two plates, and this may easily damage the face plate, the back plate or the casing of the door lock. Therefore, new parts have to be purchased. The users spend a lot of time and may even be injured during the above mentioned processes.

The present invention intends to provide a door lock and a method for installation and un-installation of the door lock without removal of the face plate.

### SUMMARY OF THE INVENTION

The present invention relates to a method of installation of a door lock, and comprises a step of providing a lock plate unit and a lock unit. The lock plate unit has an installation hole and an inside face. The inside face includes a cylinder hole which communicating with the installation hole, and the cylinder hole is a non-circular hole. The installation hole includes at least one first guide protruding from the inner periphery thereof. The lock unit includes a second guide which is engaged with the at least one first guide. The lock unit includes a latch unit which is shaped so as to be movably located in the cylinder hole. The installation hole defines a first axis and a first rotational direction which is rotated about the first axis.

A step of inserting the second guide of the lock unit into the installation hole. The second guide of the lock unit is located corresponding to the at least one first guide of the lock plate unit along the first axis. The latch unit and the cylinder hole are not located on a common axis.

A step of rotating the lock unit in the first rotational direction to position the at least one first guide in the second guide. The latch unit is positioned to share a common axis with cylinder hole via the installation hole.

The present invention also provides a method of un-installation of the door lock, and the method for un-installation of the door lock comprises a step of pushing the latch unit along the first axis to retract the latch unit into the lock unit such that the latch unit is disengaged from the cylinder hole.

A step of rotating the lock unit along the first rotational direction such that the second guide is not located corresponding to the at least one first guide.

A step of moving the lock unit away from the lock plate unit along the first axis such that the second guide is disengaged from the at least one first guide.

Besides, the present invention further provides a door lock which comprises a lock plate unit that includes an installation hole and an inside face. The inside face has a cylinder hole which is a non-circular hole and communicates with the installation hole. The installation hole has at least one first guide protruding from the inner periphery thereof. The installation hole defines a first axis and a first rotational direction which is rotated about the first axis. A lock unit includes a second guide which is engaged with the at least one first guide. The lock unit includes a latch unit which is shaped so as to be movably located in the cylinder hole.

When the lock unit is positioned at a first position, the at least one first guide is located corresponding to the second guide, and the latch unit and the cylinder hole are not located on a common axis. The latch unit is partially covered by the inside face. When the lock unit is rotated from the first position in the first rotational direction to a second position, the at least one first guide is engaged with the second guide, and the latch unit is positioned corresponding to cylinder hole so that the latch unit protrudes beyond the cylinder hole via the installation hole.

Preferably, the at least one first guide is a protrusion/recess and the second guide is a recess/protrusion.

Preferably, the recess includes a slot which is defined corresponding to the first rotational direction. The slot and the recess open toward different directions. The protrusion is engaged with the slot.

Preferably, the lock plate unit includes a face plate and a back plate which is connected to the face plate. The inside face and the cylinder hole are formed in the face plate. The installation hole and the first guide are formed on the back plate.

Preferably, the face plate is connected to the back plate by way of snapping, punching, force-fitting, riveting, welding, gluing or pressing.

Preferably, the face plate includes at least one connection portion. The back plate includes at least one bore. The face plate is connected to the back plate by connecting the at least one connection portion to the at least one bore.

Preferably, the lock unit includes a first casing and a second casing which is connected to the first casing to define the second guide.

Preferably, the lock unit includes a driving member which is connected to a transmission member. The transmission member is connected to the latch unit. At least one spring is located between the lock unit and the latch unit.

Preferably, the lock unit includes a first block and a second block. The latch unit includes a first latch and a second latch. The first block is connected between the transmission member and the first latch. The second block has one side thereof connected to the first block, and a distal end of the second block is connected to the second latch.

Preferably, the driving member includes a first rotatable member which includes a first protrusion. The transmission member includes a first stop which is located corresponding to the first protrusion. The first rotatable member defines a second axis and a second rotational direction which is rotated about the second axis. When the latch unit is moved to an unlocked position, the first rotatable member is rotated in the second rotational direction and drives the transmission member.

Preferably, the driving member includes a second rotatable member which includes a second protrusion. The transmission member includes a second stop which is located corresponding to the second protrusion. The second rotatable member defines a third axis and a third rotational direction which is rotated about the third axis. When the latch unit is moved to the unlocked position, the second rotatable member is rotated in the third rotational direction and drives the transmission member.

Preferably, the first rotatable member includes a first transmission hole which is located at the second axis. The second rotatable member includes a second transmission hole which is located at the third axis. An axle is selectively connected to the first transmission hole or the second transmission hole. When the driving member is moved to the unlocked position, and the axle is connected to the first transmission hole. The axle drives the first rotatable member via the first transmission hole. When the latch unit is moved to the unlocked position, and the axle is connected to the second transmission hole, the axle drives the second rotatable member via the second transmission hole.

The advantages of the present invention are that the lock unit is simply installed to the installation hole along the first axis, and then is rotated in the first rotational direction, the first and second guides are connected with each other at the first axis. At this position, the latch unit extends through the cylinder hole which is not a circular hole. The shape of the latch unit is shaped to be matched with the cylinder hole, so as to be positioned in the first rotational direction. The installation of the door lock is easy and simplified by rotating the latch unit along the first axis to securely position the latch unit and the lock unit. The time and labor required for installing the door lock are minimized. The latch unit and the lock unit are securely connected to each other, and do not loosen by foreign force.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the door lock of the present invention;

FIG. 2 is an exploded view of the door lock of the present invention;

FIG. 3 shows that the second guide is to be moved toward the first guide when the lock unit is connected to the lock plate unit;

FIG. 4 is a side view to show that the first guide is connected to the second guide along the axis;

FIG. 5 is an end view to show that the latch unit is stopped;

FIG. 6 shows that the first guide is rotated in the first rotational direction and engaged with the slot of the second guide;

FIG. 7 shows that the latch unit is pushed inward when the door lock is to be un-installed;

FIG. 8 is a cross sectional view, taken along line A-A in FIG. 1, and shows the status in FIG. 7;

FIG. 9 shows another view of the door lock of the present invention;

FIG. 10 is a cross sectional view, taken along line B-B in FIG. 1;

FIG. 11 shows that the first rotatable member in FIG. 9 is rotated to drive the transmission member, and

FIG. 12 is a cross sectional view, taken along line B-B in FIG. 1, and shows the status in FIG. 11.

### DETAILED DESCRIPTION OF THE PREFERRED EMBODIMENT

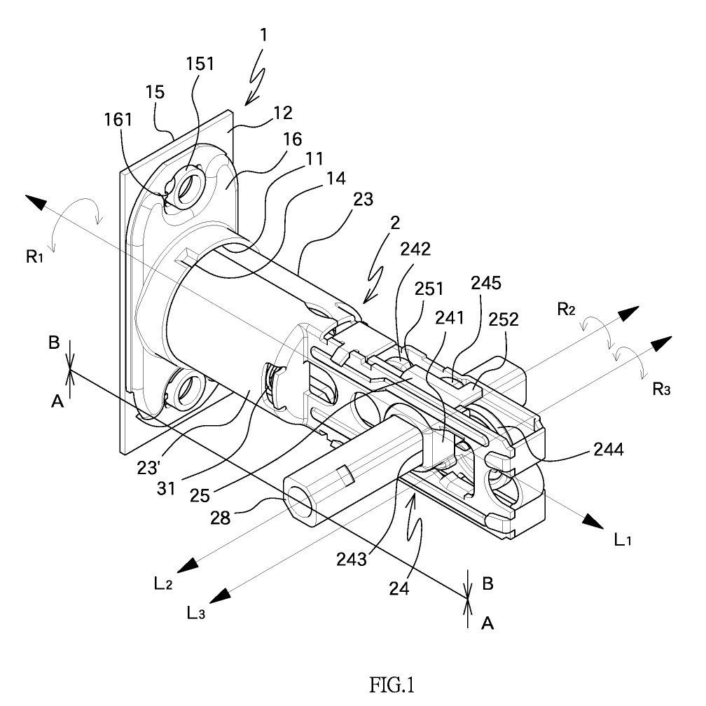

Referring to FIGS. 1 to 3, the door lock of the present invention comprises a lock plate unit 1 having an installation hole 11 and an inside face 12. The inside face 12 includes a cylinder hole 13 which is a non-circular hole and communicates with the installation hole 11. The installation hole 11 includes at least one first guide 14 protruding from the inner periphery thereof. The installation hole 11 defines a first axis L1 and a first rotational direction R1 which is rotated about the first axis L1.

A lock unit 2 includes a second guide 21 which is engaged with the at least one first guide 14. The lock unit 2 has a latch unit 3 which is shaped so as to be movably located in the cylinder hole 13.

When the lock unit 2 is positioned at a first position, the at least one first guide 14 is located corresponding to the second guide 21, and the latch unit 3 and the cylinder hole 13 are not located on a common axis. The latch unit 3 is partially covered by the inside face 12. When the lock unit 2 is rotated from the first position along the first rotational direction R1 to a second position, the at least one first guide 14 is engaged with the second guide 21. The latch unit 3 is positioned corresponding to cylinder hole 13 so that the latch unit 3 protrudes beyond the cylinder hole 13 via the installation hole 11.

In one embodiment, the first rotational direction R1 can be clockwise or counter clockwise. Therefore, the first and second guides 14, 21 are designed such that when either of them is rotated, or both of them are rotated in two opposite directions, the first and second guides 14, 21 are connected with each other.

In one embodiment, the first guide 14 is a protrusion/recess and the second guide 21 is a recess/protrusion. The protrusion can be made integrally or by way of pressing. In this embodiment, the first guide 14 is a protrusion and the second guide 21 is a recess. The protrusion is engaged with the recess to be positioned. The recess includes a slot 22 which is defined corresponding to the first rotational direction R1. The slot 22 and the recess open toward different directions. The protrusion is engaged with the slot 22.

The lock plate unit 1 includes a face plate 15 and a back plate 16 which is connected to the face plate 15. The inside face 12 and the cylinder hole 13 are formed in the face plate 15, and the installation hole 11 and the first guide 14 are formed on the back plate 16. The shape of the face plate 15 can be made to be a rectangular with angled corners or rounded corners according to needs. In this embodiment, the face plate 15 is a rectangular with angled corners.

The face plate 15 is connected to the back plate 16 by way of snapping, punching, force-fitting, riveting, welding, gluing or pressing. In another embodiment, the face plate 15 includes at least one connection portion 151, and the back plate 16 includes at least one bore 161. The face plate 15 is connected to the back plate 16 by connecting the at least one connection portion 151 to the at least one bore 161. After the at least one connection portion 151 is connected to the at least one bore 161, the at least one connection portion 151 and the at least one bore 161 are secured to each other by way of snapping, punching, force-fitting, riveting, welding, gluing or pressing.

The lock unit 2 includes a first casing 23 and a second casing 23′ which is connected to the first casing 23 to define the second guide 21.

The method of installation of the door lock of the present invention comprises:

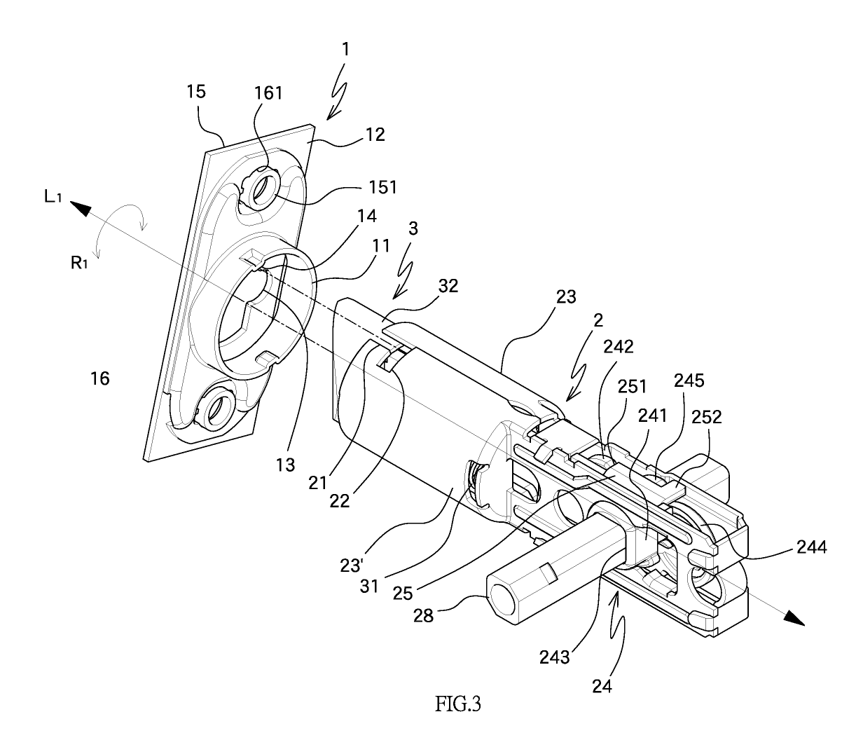

Step 001: as shown in FIG. 3, the lock plate unit 1 can be a one-piece unit or includes a face plate 15 and a back plate 16. The face plate 15 includes the inside face 12 and the cylinder hole 13. The back plate 16 includes the installation hole 11 and the first guide 14. If the lock plate unit 1 is a one-piece unit, the lock unit 2 is directly connected to the lock plate unit 1. If the lock plate unit 1 is composed of the face plate 15 and the back plate 16, the face plate 15 is connected to the back plate 16.

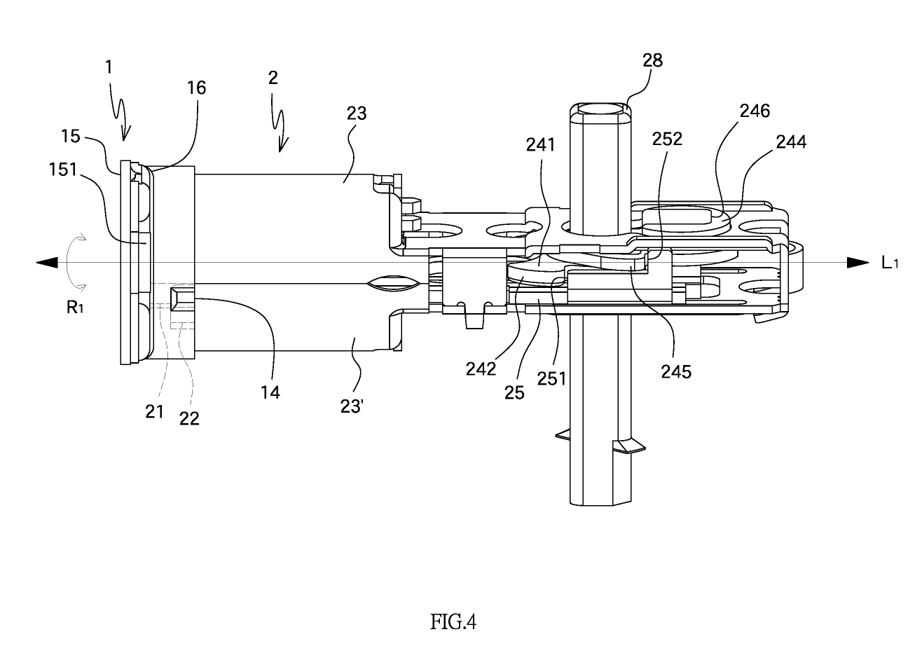

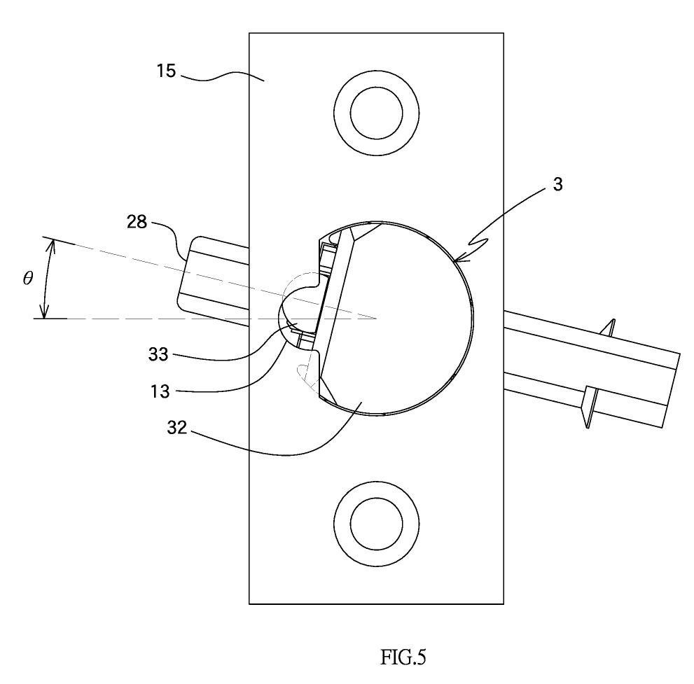

Step 002: as shown in FIG. 3, the first guide 14 of the lock plate unit 1 is located corresponding to the second guide 21 of the lock unit 2 from one end of the installation hole 11. The first guide 14 which is the protrusion is engaged with the second guide 21 which is the recess. The recess is parallel to the first axis L1, as shown in FIG. 4, the protrusion will be in contact with the inner end of the recess. As shown in FIG. 5, the latch unit 3 and the cylinder hole 13 are not located on a common axis, there is an angle “θ” formed between the latch unit 3 and the cylinder hole 13. The latch unit 3 is stopped by the inside face 12 and cannot protrude through the cylinder hole 13.

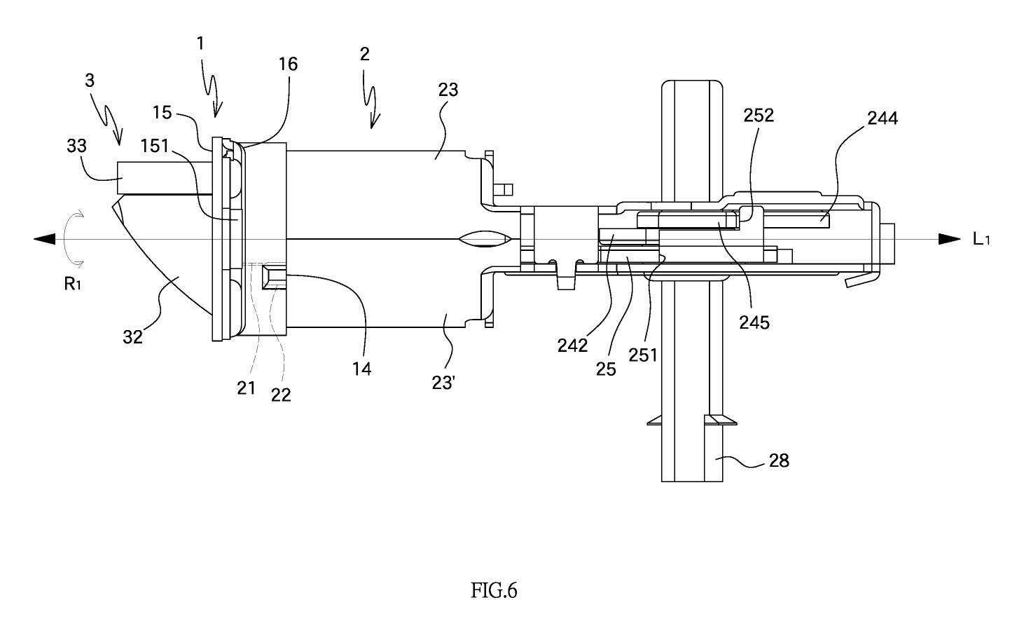

Step 003: as shown in FIG. 6, when rotating the lock unit 2 in the first rotational direction R1 to guide the second guide 21 to be positioned at the first guide 14. In this embodiment, the slot 22 is perpendicular to and communicates with the recess (the second guide 21) so that the opening of the slot 22 is located corresponding to the first rotational direction R1. Therefore, the protrusion (the first guide 14) is engaged with the slot 22 (the second guide 21). At this position, the latch unit 3 is located corresponding to the cylinder hole 13. That is to say, the lock unit 2 is rotated the angle “θ” as mentioned before to engage the protrusion (the first guide 14) with the slot 22 (the second guide 21), and the latch unit 3 is located corresponding to the cylinder hole 13 and is able to protrude beyond the cylinder hole 13 via the installation hole 11. Because the cylinder hole 13 and the latch unit 3 both are non-circular, so that the latch unit 3 is stopped by the inside of the cylinder hole 13 in the first rotational direction R1, so that the lock unit 2 cannot be rotated. As for the direction of the first axis L1, the protrusion is engaged with the slot 22 such that the lock unit 2 is well positioned relative to the lock plate unit 1.

When separating the lock unit 2 from the lock plate unit 1 to replace the lock unit 2 or the lock plate unit 1, the following steps are proceeded:

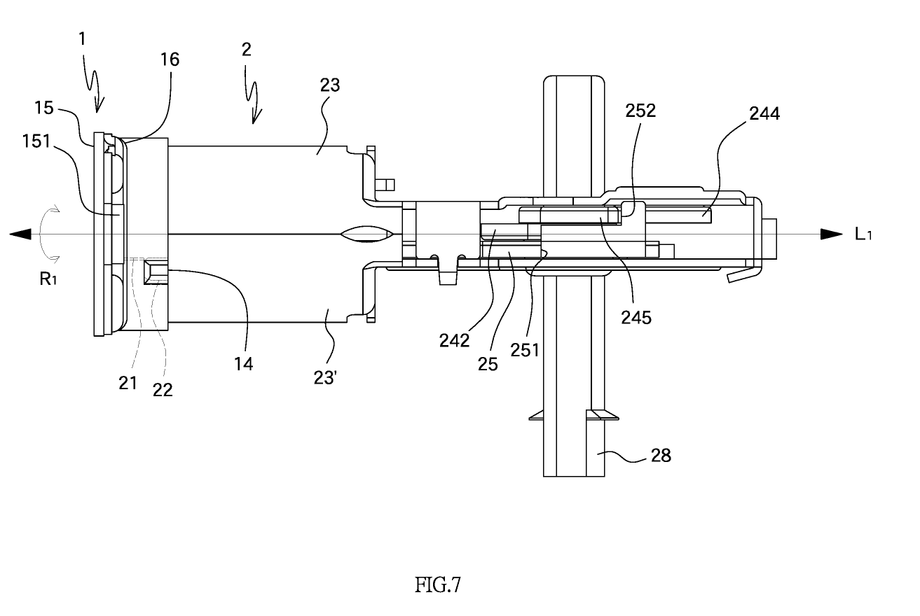

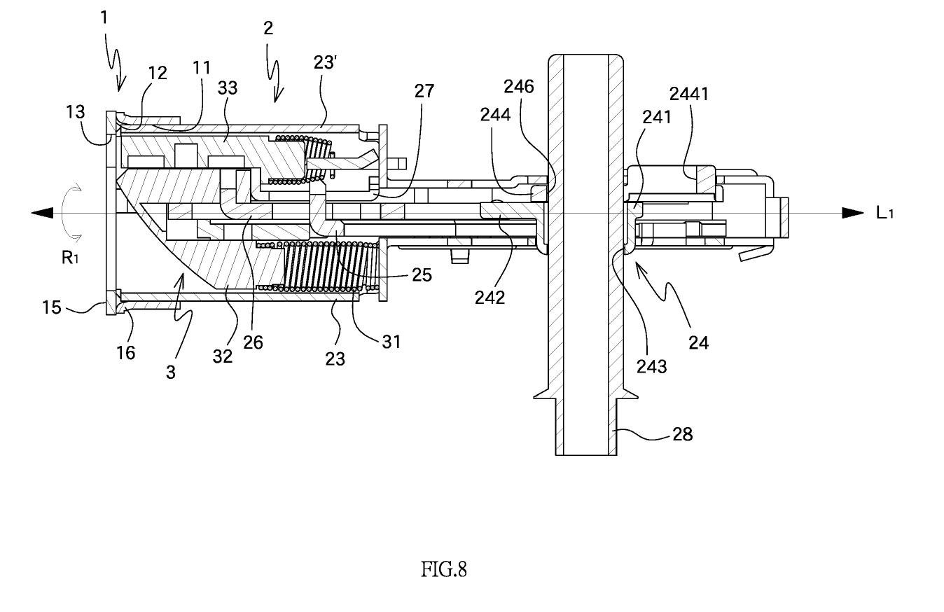

Step 004: as mentioned before, because the cylinder hole 13 and the latch unit 3 both are non-circular, the latch unit 3 is stopped by the inside of the cylinder hole 13 in the first rotational direction R1, so that the lock unit 2 cannot be rotated. Therefore, the latch unit 3 is pushed in the direction of the first axis L1, as shown in FIGS. 7 and 8, such that the latch unit 3 is retracted into the lock unit 2 and can be removed from the cylinder hole 13.

Step 005: after the latch unit 3 is removed from the cylinder hole 13, the lock unit 2 can be rotated in the first rotational direction R1. It is noted that this time the direction of rotation is opposite to that when engaging the protrusion with the slot. As shown in FIG. 4, the first guide is not positioned by the slot 22, so that the protrusion is removed from the slot 22 and contacts the inside of the recess.

Step 006: moving the lock unit 2 away from the lock plate unit 1 in the direction of the first axis L1, so that the second guide 21 is separated from the first guide 14, and the lock unit 2 and the lock plate unit 1 are dis-connected.

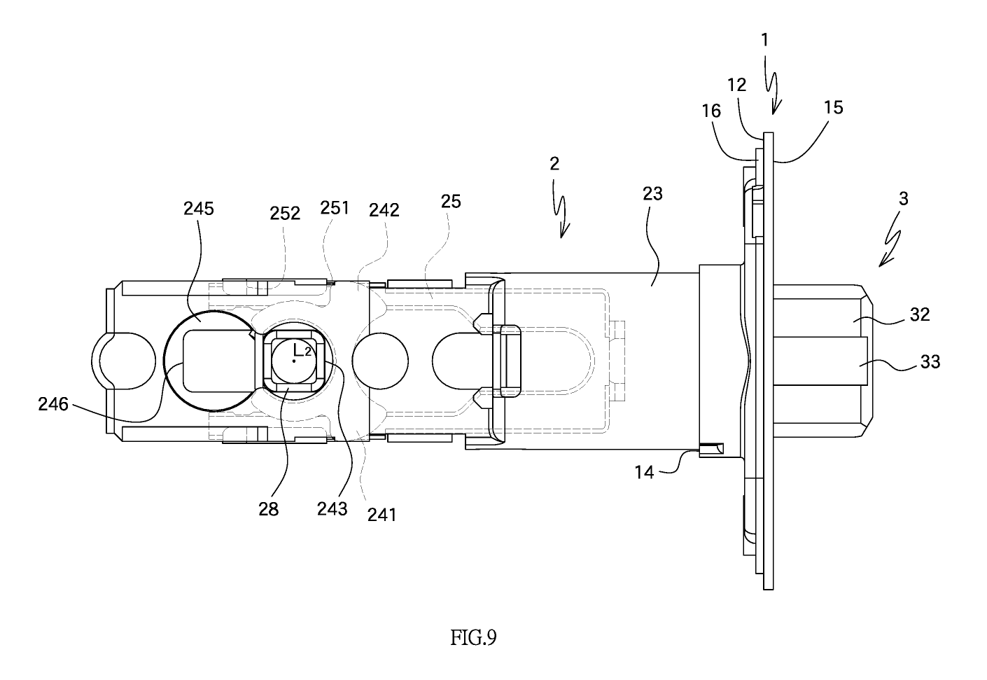

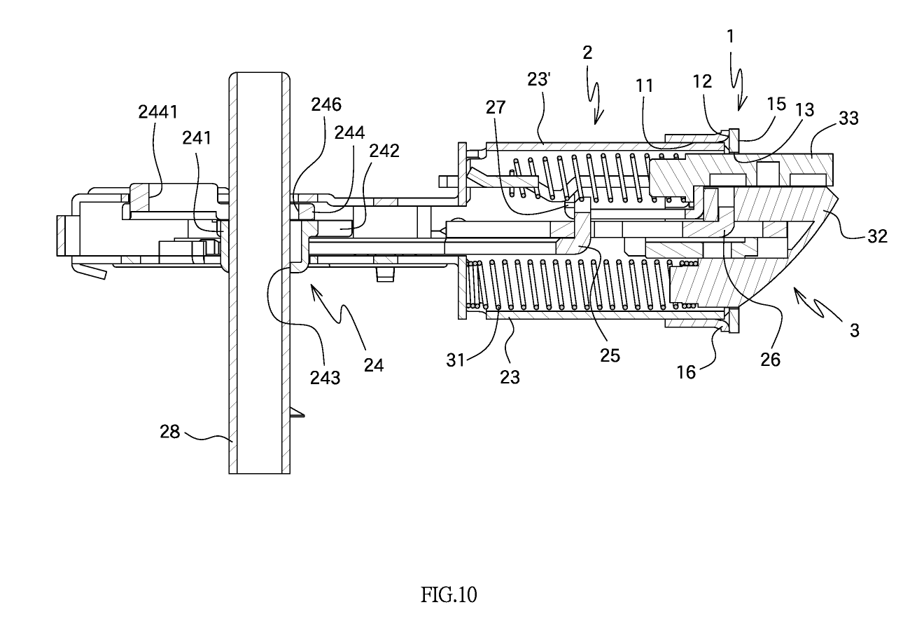

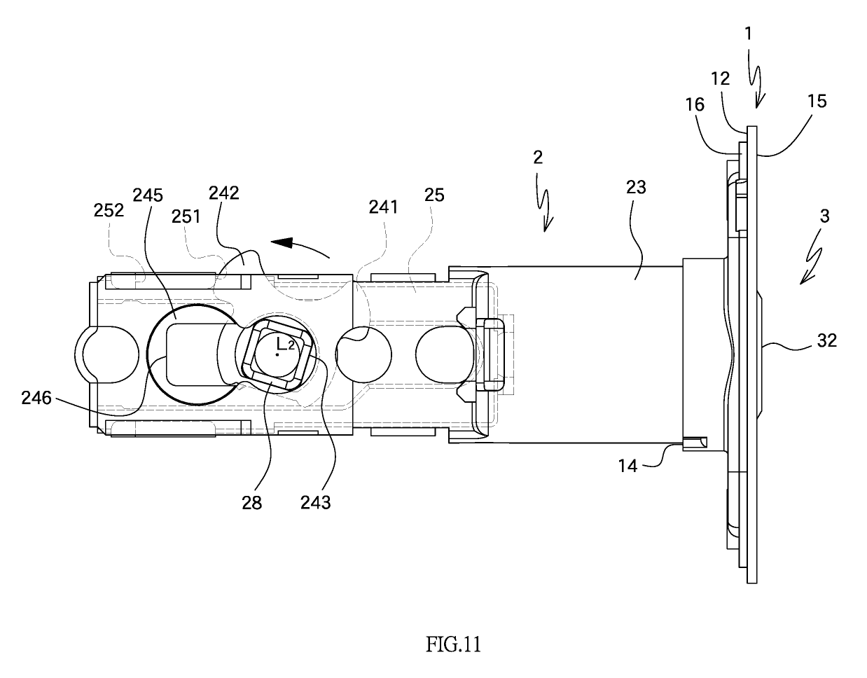

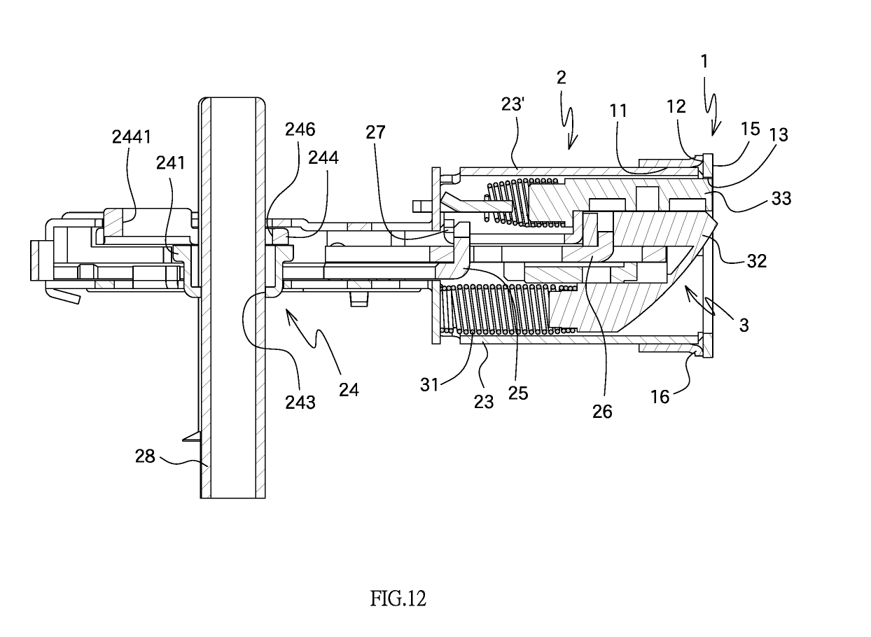

As shown in FIGS. 9 and 10, when the latch unit 3 is located at a locked position, the latch unit 3 protrudes beyond the cylinder hole 13. When the latch unit 3 is located at an unlocked position, the latch unit 3 does not protrude beyond the cylinder hole 13 as shown in FIGS. 11 and 12. Specifically, the lock unit 2 includes a driving member 24 which is connected to a transmission member 25. The transmission member 25 is connected to the latch unit 3. At least one spring 31 is located between the lock unit 2 and the latch unit 3, such that when latch unit 3 moves to the unlocked position, the driving member 24 is applied by a force to move the transmission member 25 to restrict the latch unit 3 from protruding beyond the cylinder hole 13, while the at least one spring 31 is compressed by the latch unit 3. Therefore, when at least one spring 31 is released, the latch unit 3 is applied by the recovery force, the latch unit 3 protrudes beyond the cylinder hole 13 and is located at the locked position. However, as shown in FIG. 5, when the latch unit 3 is not located corresponding to the cylinder hole 13, the latch unit 3 is stopped by the inside face 12 and cannot protrude beyond the cylinder hole 13.

In one embodiment, the lock unit 2 includes a first block 26 and a second block 27. The latch unit 3 includes a first latch 32 and a second latch 33 for anti-theft purpose. By the first latch 32 and the second latch 33, the shape of the latch unit 3 is matched with the cylinder hole 13. The first block 26 is connected between the transmission member 25 and the first latch 32. The second block 27 has one side thereof connected to the first block 26, and a distal end of the second block 27 is connected to the second latch 33.

In one embodiment, the driving member 24 includes a first rotatable member 241 which includes a first protrusion 242. The transmission member 25 includes a first stop 251 which is located corresponding to the first protrusion 242. The first rotatable member 241 defines a second axis L2 and a second rotational direction R2 which is rotated about the second axis L2. When the latch unit 3 is moved to an unlocked position, the first rotatable member 241 is rotated in the second rotational direction R2 and drives the transmission member 25.

In one embodiment, the first rotatable member 241 includes a first transmission hole 243 which is located at the second axis L2. An axle 28 is connected to the first transmission hole 243 and a handle (not shown) is connected to the axle 28 so that the axle 28 is rotated via operation of the handle.

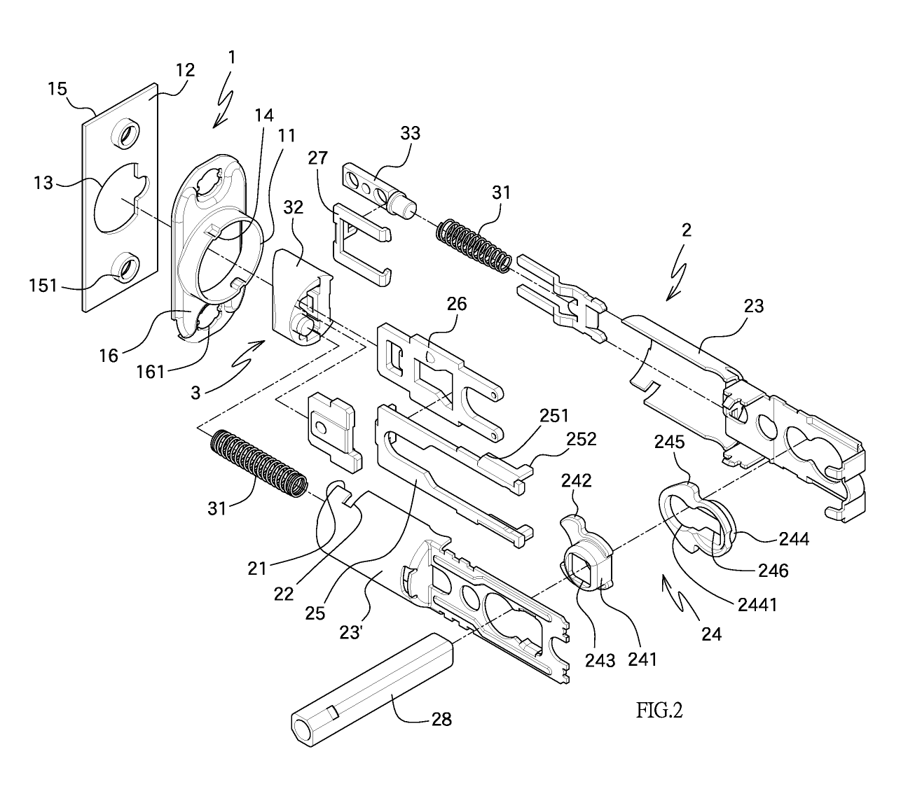

As shown in FIGS. 9 and 10, when in the locked position, the axle 28 does not drive the first rotatable member 241. As shown in FIGS. 2 and 11, when in the unlocked position, the axle 28 is rotated and drives the first rotatable member 241 via the first transmission hole 243, so that the first protrusion 242 moves the transmission member 25 by the first stop 251. As shown in FIG. 12, because the first block 26 is connected to the transmission member 25, so that the first block 26 drives the first latch 32 to the unlocked position by the transmission member 25. In the meanwhile, the second block 27 drives the second latch 33 to the unlocked position by the first block 26.

In one embodiment, the driving member 24 includes a second rotatable member 244 which includes a second protrusion 245. The transmission member 25 includes a second stop 252 which is located corresponding to the second protrusion 245. The second rotatable member 244 defines a third axis L3 and a third rotational direction R3 which is rotated about the third axis L3. The second and third axes L2, L3 are parallel to each other. A gap is formed between the second and third axes L2, L3. When the latch unit 3 is moved to the unlocked position, the second rotatable member 244 is rotated in the third rotational direction R3 and drives the transmission member 25.

In one embodiment, the second rotatable member 244 includes a second transmission hole 246 which is located at the third axis L3. The axle 28 is selectively connected to the second transmission hole 246. When the axle 28 is rotated to the unlocked position, the axle 28 rotates the second rotatable member 244 via the second transmission hole 246 such that the transmission member 25 is operated to drive the first and second latches 32, 33 to the unlocked position.

In one embodiment, the first and second rotatable members 241, 244 are made by way of pressing or cold forging. The axle 28 is made by way of cold forging.

In order to be used with the doors of different thicknesses, as shown in FIGS. 2, 9 and 11, the axle 28 is selectively connected to the first transmission hole 243 of the first rotatable member 241, or the second transmission hole 246 of the second rotatable member 244 to avoid from interference between the first and second rotatable members 241, 244. In one embodiment, in order to save space, the second rotatable member 244 includes a through hole 2441 which is located corresponding to the first transmission hole 243. The diameter of the through hole 2441 is larger than that of the axle 28. When the axle 28 is installed to the first transmission hole 243 of the first rotatable member 241, the axle 28 is rotatable in the through hole 2441, can not rotate the second rotatable member 244.

While we have shown and described the embodiment in accordance with the present invention, it should be clear to those skilled in the art that further embodiments may be made without departing from the scope of the present invention.

What is claimed is:

1. An operational method for a door lock, comprising:
an installation method of the door lock and an un-installation method of the door lock, the installation method of the door lock comprising:
a step of providing a lock plate unit and a lock unit, the lock plate unit having an installation hole and an inside face, the inside face having a cylinder hole which communicating with the installation hole, the cylinder hole being a non-circular hole, the installation hole having at least one first guide protruding from an inner periphery thereof, the lock unit having a second guide which is engaged with the at least one first guide, the lock unit having a latch unit which is shaped so as to be movably located in the cylinder hole, the installation hole defining a first axis and a first rotational direction which is rotated about the first axis;
a step of inserting the second guide of the lock unit into the installation hole, the second guide of the lock unit located corresponding to the at least one first guide of the lock plate unit along the first axis, the latch unit and the cylinder hole being not located on a common axis, and
a step of rotating the lock unit in the first rotational direction to position the at least one first guide in the second guide, and the latch unit being positioned to share a common axis with cylinder hole via the installation hole.

2. The method as claimed in claim 1, wherein the at least one first guide is a protrusion/recess and the second guide is a recess/protrusion.

3. The method as claimed in claim 2, wherein the recess includes a slot which is defined corresponding to the first rotational direction, the slot and the recess open toward different directions, the protrusion is engaged with the slot.

4. The method as claimed in claim 1, wherein the lock plate unit includes a face plate and a back plate which is connected to the face plate, the inside face and the cylinder hole are formed in the face plate, the installation hole and the first guide are formed on the back plate.

5. The method as claimed in claim 4, wherein the face plate is connected to the back plate by way of snapping, punching, force-fitting, riveting, welding, gluing or pressing.

6. The method as claimed in claim 1, wherein the lock unit includes a first casing and a second casing which is connected to the first casing to define the second guide.

7. The method as claimed in claim 1, wherein the lock unit includes a driving member which is connected to a transmission member, the transmission member is connected to the latch unit, at least one spring is located between the lock unit and the latch unit.

8. The method as claimed in claim 7, wherein the lock unit includes a first block and a second block, the latch unit includes a first latch and a second latch, the first block is connected between the transmission member and the first latch, the second block has one side thereof connected to the first block, and a distal end of the second block is connected to the second latch.

9. The method as claimed in claim 8, wherein the driving member includes a first rotatable member which includes a first protrusion, the transmission member includes a first stop which is located corresponding to the first protrusion, the first rotatable member defines a second axis and a second rotational direction which is rotated about the second axis, when the latch unit is moved to an unlocked position, the first rotatable member is rotated in the second rotational direction and drives the transmission member.

10. The method as claimed in claim 9, wherein the driving member includes a second rotatable member which includes a second protrusion, the transmission member includes a second stop which is located corresponding to the second protrusion, the second rotatable member defines a third axis and a third rotational direction which is rotated about the third axis, when the latch unit is moved to the unlocked position, the second rotatable member is rotated in the third rotational direction and drives the transmission member.

11. The method as claimed in claim 10, wherein the first rotatable member includes a first transmission hole which is located at the second axis, the second rotatable member includes a second transmission hole which is located at the third axis, an axle is selectively connected to the first transmission hole or the second transmission hole, when the driving member is moved to the unlocked position, and the axle is connected to the first transmission hole, the axle drives the first rotatable member via the first transmission hole, when the latch unit is moved to the unlocked position, and the axle is connected to the second transmission hole, the axle drives the second rotatable member via the second transmission hole.

12. The method as claimed in claim 1, wherein the un-installation method of the door lock comprising:
a step of pushing the latch unit along the first axis to retract the latch unit into the lock unit such that the latch unit is disengaged from the cylinder hole;
a step of rotating the lock unit along the first rotational direction such that the second guide is not located corresponding to the at least one first guide, and
a step of moving the lock unit away from the lock plate unit along the first axis such that the second guide is disengaged from the at least one first guide.

13. A door lock comprising:
a lock plate unit having an installation hole and an inside face, the inside face having a cylinder hole which communicating with the installation hole, the cylinder hole being a non-circular hole, the installation hole having at least one first guide protruding from an inner periphery thereof, the installation hole defining a first axis and a first rotational direction which is rotated about the first axis, and
a lock unit having a second guide which is engaged with the at least one first guide, the lock unit having a latch unit which is shaped so as to be movably located in the cylinder hole, when the lock unit is positioned at a first position, the at least one first guide is located corresponding to the second guide, and the latch unit and the cylinder hole are not located on a common axis, the latch unit is partially covered by the inside face, when the lock unit is rotated from the first position along the first rotational direction to a second position, the at least one first guide is engaged with the second guide, the latch unit is positioned corresponding to cylinder hole so that the latch unit protrudes beyond the cylinder hole via the installation hole.

14. The door lock as claimed in claim 13, wherein the at least one first guide is a protrusion/recess and the second guide is a recess/protrusion.

15. The door lock as claimed in claim 14, wherein the recess includes a slot which is defined corresponding to the first rotational direction, the slot and the recess open toward different directions, the protrusion is engaged with the slot.

16. The door lock as claimed in claim 13, wherein the lock plate unit includes a face plate and a back plate which is connected to the face plate, the inside face and the cylinder hole are formed in the face plate, the installation hole and the first guide are formed on the back plate.

17. The door lock as claimed in claim 16, wherein the face plate is connected to the back plate by way of snapping, punching, force-fitting, riveting, welding, gluing or pressing.

18. The door lock as claimed in claim 13, wherein the lock unit includes a first casing and a second casing which is connected to the first casing to define the second guide.

19. The door lock as claimed in claim 13, wherein the lock unit includes a driving member which is connected to a transmission member, the transmission member is connected to the latch unit, at least one spring is located between the lock unit and the latch unit.

20. The door lock as claimed in claim 19, wherein the lock unit includes a first block and a second block, the latch unit includes a first latch and a second latch, the first block is connected between the transmission member and the first latch, the second block has one side thereof connected to the first block, and a distal end of the second block is connected to the second latch.

21. The door lock as claimed in claim 20, wherein the driving member includes a first rotatable member which includes a first protrusion, the transmission member includes a first stop which is located corresponding to the first protrusion, the first rotatable member defines a second axis and a second rotational direction which is rotated about the second axis, when the latch unit is moved to an unlocked position, the first rotatable member is rotated in the second rotational direction and drives the transmission member.

22. The door lock as claimed in claim 21, wherein the driving member includes a second rotatable member which includes a second protrusion, the transmission member includes a second stop which is located corresponding to the second protrusion, the second rotatable member defines a third axis and a third rotational direction which is rotated about the third axis, when the latch unit is moved to the unlocked position, the second rotatable member is rotated in the third rotational direction and drives the transmission member.

23. The door lock as claimed in claim 22, wherein the first rotatable member includes a first transmission hole which is located at the second axis, the second rotatable member includes a second transmission hole which is located at the third axis, an axle is selectively connected to the first transmission hole or the second transmission hole, when the driving member is moved to the unlocked position, and the axle is connected to the first transmission hole, the axle drives the first rotatable member via the first transmission hole, when the latch unit is moved to the unlocked position, and the axle is connected to the second transmission hole, the axle drives the second rotatable member via the second transmission hole.
